(19) United States
(12) Patent Application Publication
(10) Pub. No.: US 2025/0230022 A1
(43) Pub. Date: Jul. 17, 2025

(54) Multi-Purpose Jack System

(71) Applicant: Stephen William Snyder, Wilmington, NC (US)

(72) Inventor: Stephen William Snyder, Wilmington, NC (US)

(21) Appl. No.: 19/022,293

(22) Filed: Jan. 15, 2025

Related U.S. Application Data
(60) Provisional application No. 63/621,146, filed on Jan. 16, 2024.

(51) Int. Cl. B66F 3/00

(52) U.S. Cl. CPC B66F 3/00; B66F 2700/025

(57) ABSTRACT

A novel jack system that eliminates structures likely to fail that are common in other jack systems and includes a variety of attachments that allow the system to raise objects that are lower to the ground or higher off the ground than traditional jacks can accommodate. The system includes a locking mechanism that transfers the weight lifted by the jack to a central main support shaft. The system includes attachments that allow a user to lift a marine vessel such as a personal watercraft, an object that has fallen on the ground such as a trailer, and/o the front of a vehicle such as a lawnmower. The attachments are interchangeable and adjustable in height and position.

### BACKGROUND OF THE INVENTION

### (a) Field of the Invention

The present disclosure is in the technical field of mechanical lifting systems. More particularly, the present disclosure relates to a novel jack system that includes a variety of different attachments.

### (b) Background Art

A jack is a mechanical device that is used to lift heavy objects; jacks have been in use since the 1800s. There are a variety of different types of jacks, but most households will have either a mechanical jack or a hydraulic jack. Mechanical jacks use a screw thread to move a support frame and thus lift an object. Hydraulic jacks accomplish the same task using pressurized liquid. There are also specialized jacks that are designed to raise specific vehicles or structures including house jacks and snowmobile jacks. Despite their longstanding use, jacks on the market typically present a number of problems.

First and foremost is the positioning of the jack. Most jacks have to be placed directly under the load they are going to lift and thus the load needs to be a certain distance off the ground just to allow the user to position the jack. For example, a bottle jack must be placed underneath a vehicle to be used to raise the same vehicle. Furthermore, because jacks on the market now need to be placed underneath a load, they cannot be used to lift an object that is already on the ground or too close to the ground to position the jack.

In addition, jacks such as bottle jacks only lift the object at one specific point and are thus unstable requiring the use of other equipment or jacks to ensure that the load does not fall. The National Highway Traffic Safety Administration (NHBTSA) estimates that there are over four thousand injuries every year in the United States that are associated with jack failures of one kind or another. Most of these injuries are caused by the load slipping or falling off of the jack during use. Other jacks require a ratchet and pawl system to hold the jack in place in a particular position or at a particular height. Some jack failures are a direct result of the failure of such ratchet and pawl systems. In addition, there have been a number of recalls related to products that use the ratchet and pawl system. Hydraulic jacks suffer from failures resulting from leaks and/or a loss of pressure inside the device. Devices with telescoping main support shafts are susceptible to collapse if too much weight is placed on them.

In addition, most jacks are made such that they are low to the ground so that the user can place the jack underneath the load to be lifted. However, this tends to limit the height at which the jack can position an object as the higher the jack lifts the load, the less stable the system becomes.

### BRIEF SUMMARY OF THE INVENTION

The present invention is a multipurpose, lightweight jack system that can be used to safely lift objects that are not always easy to lift with a traditional jack. The jack uses a novel locking mechanism that will not fail until or unless the fasteners or welded joints of the device fail. In addition, the system transmits the weight of the object being lifted to a main support shaft such that the weight is exerted along that main support shaft's longitudinal axis. When locked, there is simply no way to unlock or lower the device by placing additional weight on the load being lifted. There is no hydraulic system or pawl and ratchet system that can fail.

For the purposes of this disclosure, the term forward refers to a direction or side that is opposite the side of the system that includes the lever (see below). The term backward refers to a direction or side that is towards the same lever. The “front” of the device includes the portion of the jack that includes the bracket 19 and the “back” of the device is the portion of the jack that includes the lever. The term up or upwards refers to a direction that extends away from the base of the system and the ground; the term downward refers to a direction that is toward said base and the ground or other surface upon which the base rests.

A first embodiment of the presently disclosed system includes a base that includes a plurality of legs. In preferred embodiments, the base consists of a brace that engages, interlocks with or is otherwise directly attached to the plurality of legs and the main support shaft. The system can include legs that are releasably attached to the main support shaft, and preferred embodiments and the inventors anticipated best mode include at least two legs that are pivotably attached to the base such that the user can, by loosening the fasteners attaching each leg to the base and repositioning the leg before retightening the same fastener, adjust the positioning of the legs. In this way, the legs can be folded to make the device easier to transport, ship or store. Still further preferred embodiments and the inventor's anticipated best mode include two front legs that extend away from the base an angle to each other and a third opposing leg that extends away from the base in a different direction. The two front legs extend outwardly away from the front of the base and the third leg extends away from the back of the base.

The main support shaft extends vertically, upward and away from the base and is engaged by or connected to a first sleeve and a locking mechanism for the handle. The first sleeve encircles an outer surface of the main support shaft such that as it is lifted and lowered it slides up and down along the vertical length of the main support shaft.

The locking mechanism includes a plurality of arms arranged to move the sleeve up and down along the main support shaft and to lock the attached handle (see below) in place. In preferred embodiments the locking mechanism includes a first arm with a first end that is pivotably connected to the main support shaft at or near the top of said shaft, a second arm with a first end that is pivotably connected to a second end of the first arm and a second end that is pivotably connected to a bracket that extends away from the sleeve. Still further preferred embodiments and the inventor's anticipated best mode include a bend in the second arm such that the first end of that arm and the second end of that arm are connected by a middle portion of the second arm that includes an obtuse angle, i.e, each end of the arm extends away from a central or middle portion at an angle to the other end of the arm that is greater than 90 degrees.

The locking mechanism is directly attached to a handle or lever that moves the locking mechanism and thus, the arms and bracket to which it is attached, between a fully lowered position and a fully raised position. In preferred embodiments the lever is not pivotably attached to the locking mechanism. In still further preferred embodiments, the lever is welded or permanently attached to a middle portion of the first arm; although, it is not necessary for the lever to be attached to the exact midpoint of the arm. The shape of the locking mechanism is key to its functioning. When the lever is raised, it moves the first arm of the locking mechanism such that it pivots at the point of contact with the main support shaft. As the first arm is moved forward by lifting the lever, the second arm pivots at the point of attachment with the first arm. The shape of the second arm is such that when the first end is raised/moved forward by the movement of the first arm and lever, the second end moves downward causing the bracket and the attached sleeve to move downward along the vertical length of the main support shaft.

In preferred embodiments, the second end of the second arm is directly attached to a bracket that is featured by or directly attached to the first sleeve. As the lever is raised, the second arm moves forward and downward and the bracket and first sleeve attached thereto move into a lowered position. As the lever is lowered, the second end of the second arm pulls the bracket causing the first sleeve to move upward along the vertical length of the main support shaft. When the lever, bracket and sleeve are in a fully raised position, the first end of the first arm will have pivoted at the attachment point with the main support shaft and the first end of the second arm will have pivoted at the point of attachment with the first arm. This moves the second end of the first arm and the first end of the second arm to a position that is behind the main support shaft. In other words, when the bracket and the sleeve are in the fully raised position the first arm is angled backward away from the main shaft and the direction in which the bracket extends. At this point, pushing down on the bracket, sleeve and/or second arm has the effect of applying force to the main support shaft along its longitudinal axis. Since the main support shaft is strongest, i.e. can accept the most weight, along this longitudinal axis, the device is stable and resists further downward movement.

The system also includes attachments that allow the user to lift different types of equipment not practical to lift with a standard prior art device. Preferred embodiments and the inventor's anticipated best mode include a second sleeve attached to an end of the bracket that is opposite the end that includes the first sleeve. This second sleeve is meant to engage with a number of different attachments that can be used with the jack. For example, one embodiment of the system includes a trailer hitch directly attached to a second sleeve of the bracket. A second embodiment features a trailer ball hitch directly attached to a support column or with a threaded structure in place of the trailer ball hitch. This support column contains a height adjustment system that includes a series of holes or apertures traversing the support column from one side to an opposing side and at least one aperture in the bracket (or second sleeve-see below) that is complementary in size and shape to the apertures in the support column such that a fastener or locking pin can be inserted through both the at last one aperture in the bracket or second sleeve and one of the plurality of apertures in the support column thereby holding it in place. The user can then adjust the height of the accessory support column by adjusting the height of that support column in relation to the second sleeve in the bracket and locking it in place with a locking pin. In some embodiments, the bracket features or includes a second sleeve that is attached to a portion of the bracket and that also includes the at least one aperture. This jack system is designed to be used to lift objects considerably higher than the standard jack; for example, the system can be used to lift a trailer or other object high enough to allow water to drain out of it.

Another similar variation of this system replaces the trailer ball hitch with a U-shaped bracket that is meant to engage with objects that do not include a coupler that accepts a trailer hitch ball or head, but instead include a horizontal structure that can engage with the U-shaped bracket. For example, this attachment can be used to lift the back end of an ATV. This attachment allows the user to lift such a vehicle without inserting the entire jack system underneath the lowest point of the vehicle, i.e. it can attach to a bar on the back of the vehicle that is already off the ground and lift that end of the vehicle without having to be placed underneath the vehicle.

Yet another attachment to be used as part of the disclosed system is designed so that it can be placed under objects that are low to the ground. A traditional jack requires a user to place part of the jack that includes the mechanism to raise the jack, underneath the device being raised. However, in this embodiment of the system and the one described above, the attachment is directly attached to the second sleeve of the bracket and extends away from the main support column allowing the user to place the attachment in position without placing the rest of the system underneath the object being moved. In this embodiment, the attachment extends downward toward the ground instead of up and away from the ground. The attachment includes an attachment support arm with an aperture complementary in size and shape to the at least one aperture featured by the bracket (or a second sleeve directly attached to the bracket). This support arm extends downward, and preferably forward away from the main support column and terminates in another arm. Alternately, the support arm can feature an angled portion. Regardless, the support arm terminates in a trailer hitch or other attachment allowing a user to engage with an object that is close to the ground. The shape of the support arm is such that it extends toward the ground and is low enough to pick up an object like a trailer that has fallen to the ground.

Yet another attachment for the system includes a platform or frame onto which a vehicle or piece of equipment like a lawnmower can be driven. As above, there is a support arm that engages with the bracket or the second sleeve and extends downward and away from the main support shaft, preferably at an angle that is not a right angle to the bracket. This support arm can also feature or include a bent or horizontal portion that extends away from the rest of the device and terminates in a platform or frame. In use, the user drives a piece of equipment such as a lawnmower, or a portion thereof, onto the platform or frame such that the equipment or a portion thereof can be raised.

### BRIEF DESCRIPTION OF THE SEVERAL VIEWS OF THE DRAWING(S)

FIG. 1 is a side perspective view of a first embodiment of the inventive jack system;

FIG. 2 is an exploded view thereof;

FIG. 3 is a perspective view of the lever and first arm thereof;

FIG. 4 is a plan view of the second arm thereof;

FIG. 5 is a perspective view of the bracket thereof;

FIG. 6 is a plan view of an embodiment of an attachment for the system;

FIG. 7 is a perspective view of an accessory support column used with the various attachments for the system;

FIG. 8A is a side plan view of an embodiment of a third attachment for the system;

FIG. 8B is a front plan view thereof;

FIG. 9A is a front perspective view of an embodiment of a fourth attachment for the system;

FIG. 9B is a side perspective view thereof;

FIG. 10 is a perspective view the stabilizer leg; and

FIG. 11 is a side plan view of an earlier embodiment of the jack system with the lever raised and the bracket lowered.

### DETAILED DESCRIPTION OF THE INVENTION

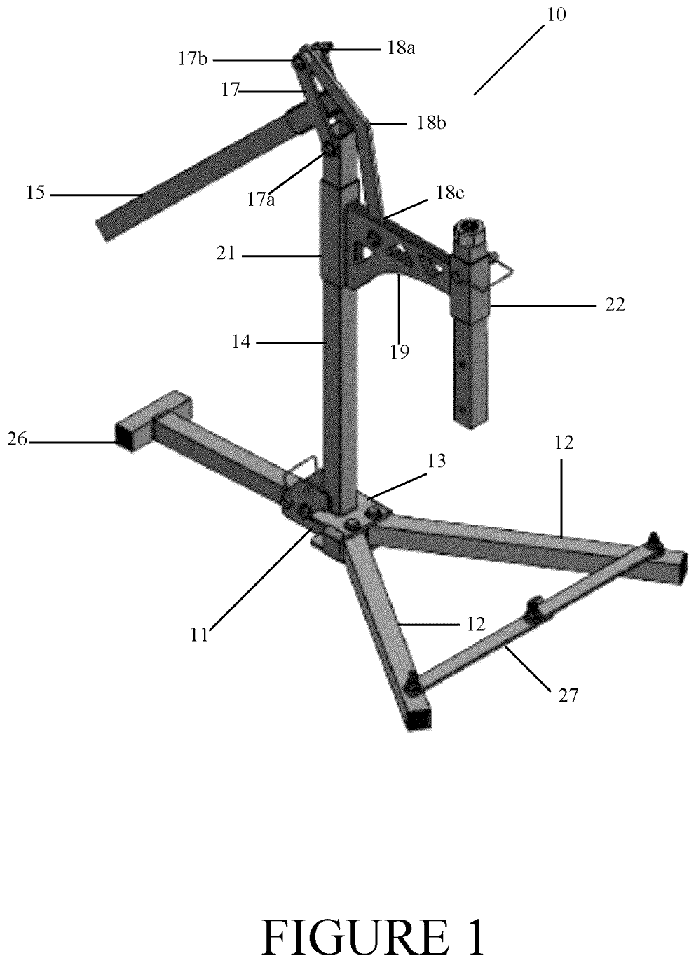

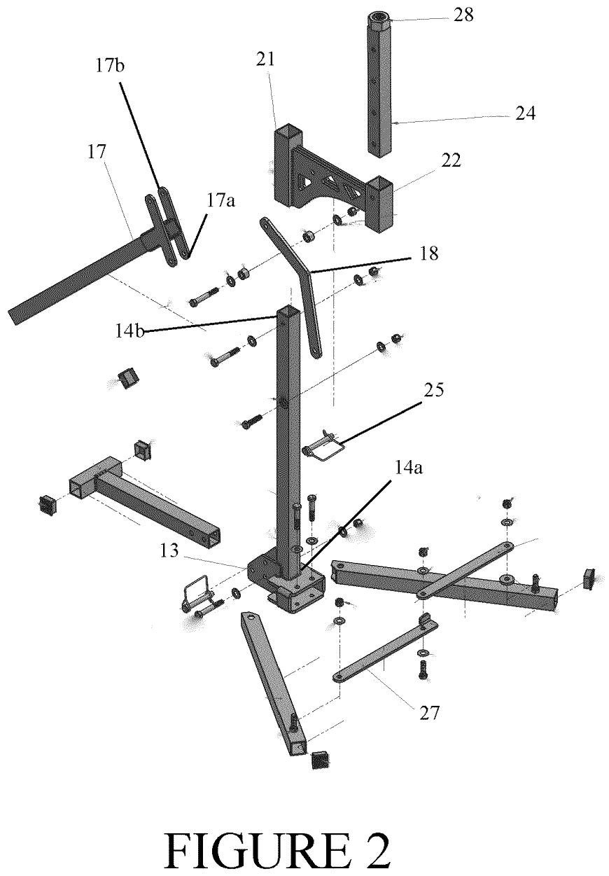

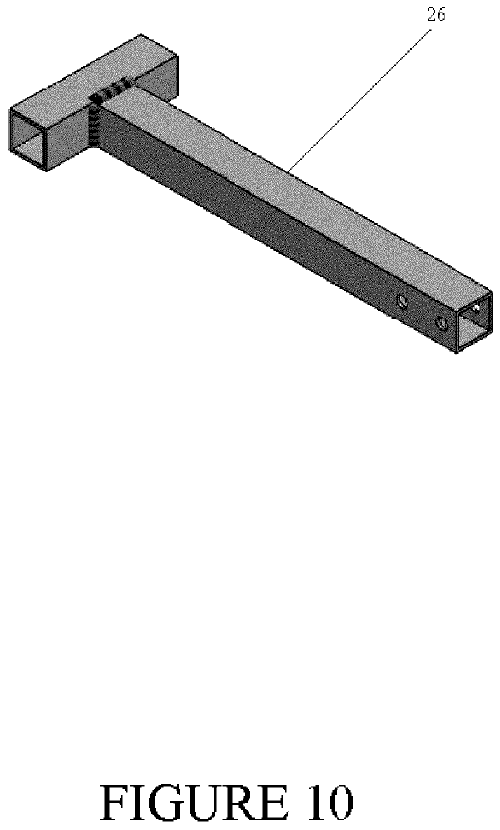

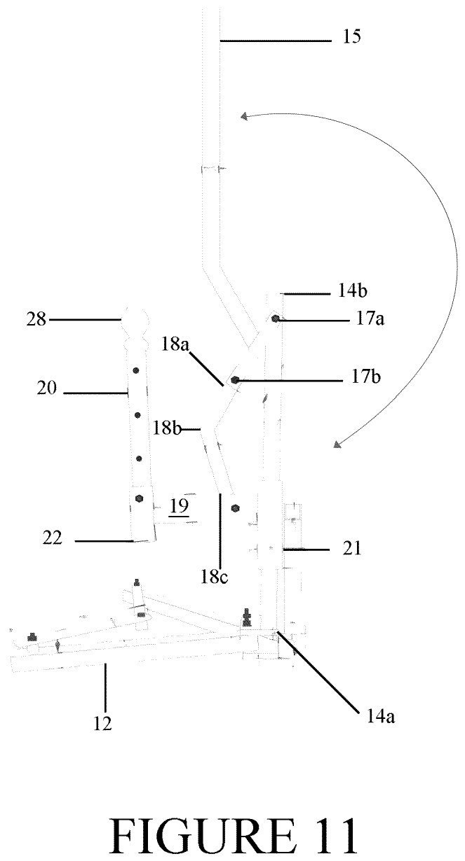

Note, the measurements in some of the figures are for illustrative purposes only and should not be ready o limit the disclosure. Referring now to the invention in more detail, FIG. 1 shows a first preferred embodiment of the disclosed jack system 10. FIG. 2 shows an exploded view of the same embodiment. The jack system 10 incudes a base 11 with a plurality of legs 12 that are, in this embodiment, releasably attached to a brace 13 that also secures the main support shaft 14 in a vertical position with respect to the ground and/or base 11. The front legs 12 are also pivotably mounted to the base 11 so that their position with respect to the rest of the device can be adjusted as needed. This way the device can be partially folded up for transportation and/or storage. Preferred embodiments and the inventor's anticipated best mode include two front legs 12 that are attached to the base 11 via a brace 13 and extend away from the base 11 toward the front of the jack 10 and a third back leg (stabilizer leg) 26 releasably attached to the base 11 and that extends away from the base toward the back of the jack 10. The stabilizer leg is also depicted in FIG. 10. The two front legs 12 can be connected via connector 27. This connector 27 serves to prevent the front legs 12 of the base 11 from spreading too far apart thereby comprising the support for the jack 10.

FIG. 1 also shows a preferred embodiment and the inventor's anticipated best mode of the locking mechanism. The main support shaft 14 is secured to the base 11 at a first end 14a and has a second end 14b that is attached to the locking mechanism. The locking mechanism includes a first arm 17, a second arm 18 and a lever or handle 15. The first arm 17 has a first end 17a and a second end 17b; the first end 17a is pivotably attached to the second end 14b of the main support shaft 14. The second end 17b of the first arm 17 is pivotably attached a first end 18a of the second arm 18. The second end 18c of the second arm 18 is pivotably attached to a bracket 19 that includes a first sleeve 21. The first sleeve 21 is positioned such that it encircles an outer surface of the main support shaft 14 and slides along the vertical length of the main support shaft 14 as it is moved up and down by the second arm 18.

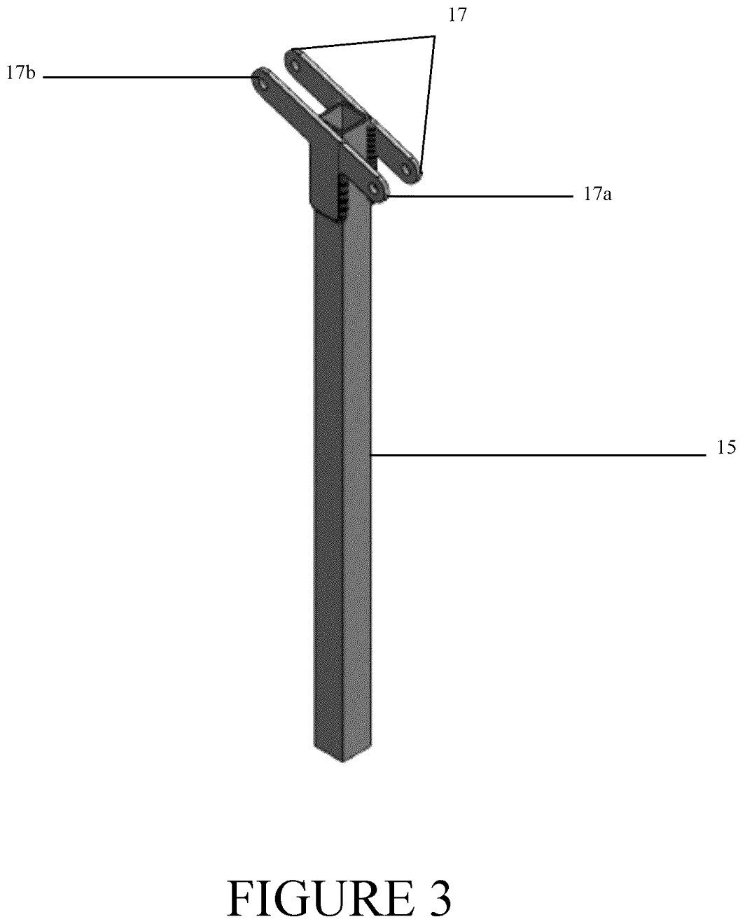

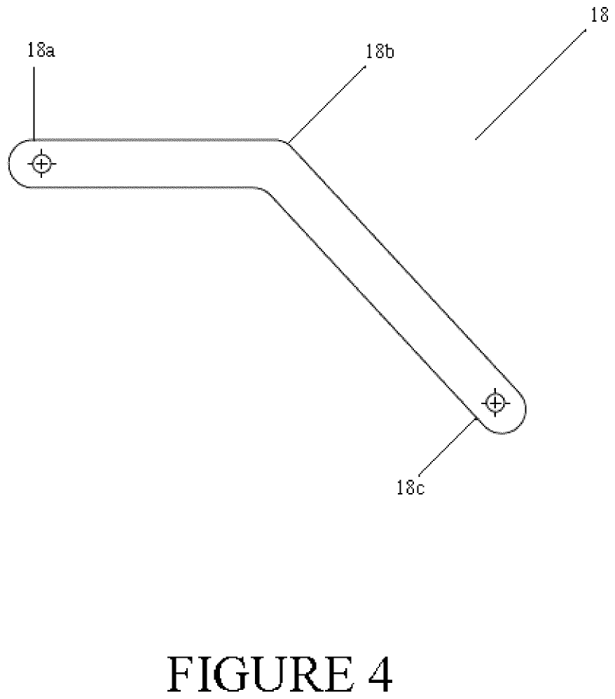

The locking mechanism also includes a lever or handle 15 attached to a portion of the first arm 17 (see also FIG. 3). The point of attachment can be varied but in preferred embodiments and the inventor's anticipated best mode, the lever 15 and the first arm 17 are made as a single piece with the lever 15 joining the first arm between the first end 17a and the second end 17b of that first arm 17. With reference to FIGS. 1 and 4, the second arm 18 includes a bent, middle portion 18b that connects the first end 18a with the second end 18c. This middle portion 18b is bent to form an obtuse angle between the first and second ends 18a, 18c of the second arm 18.

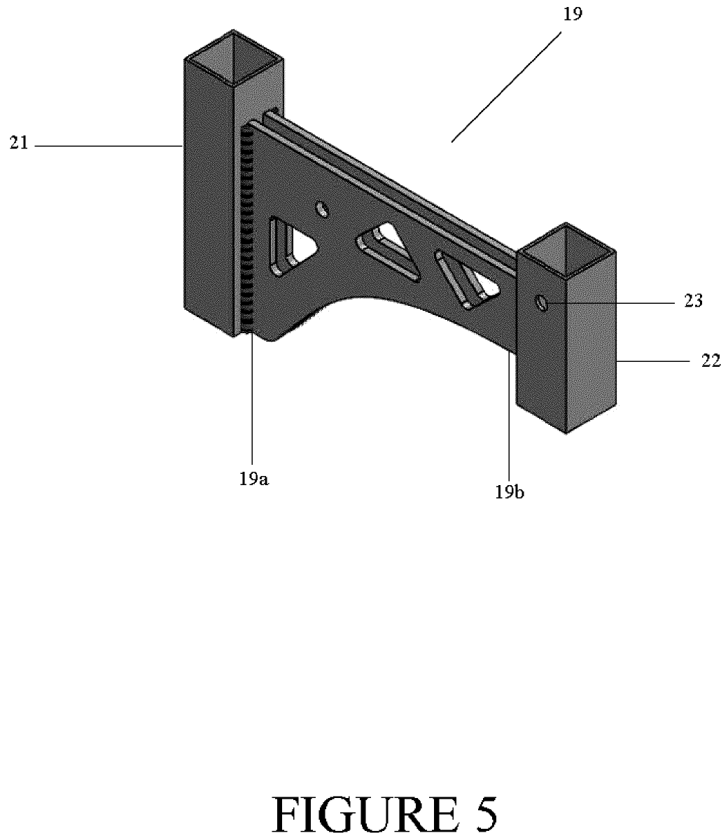

FIG. 5 shows a preferred embodiment and anticipated best mode of the bracket 19¹. This bracket 19 includes the first sleeve 21 at one end and a second sleeve 22 at a second, opposing end of the bracket 19. In preferred embodiments and the inventor's anticipated best mode, this bracket 19 is manufactured as a single structure. The first sleeve 21 encircles an outer surface of the main support shaft 14. The bracket 19 extends forward and away from the main support shaft 14 and includes the second sleeve 22 at the opposing end. The second sleeve 22 accommodates the attachments to the jack system 10 that are described below. ¹ In the provisional patent application to which this application claims priority, this structure is referred to as a “third arm.”

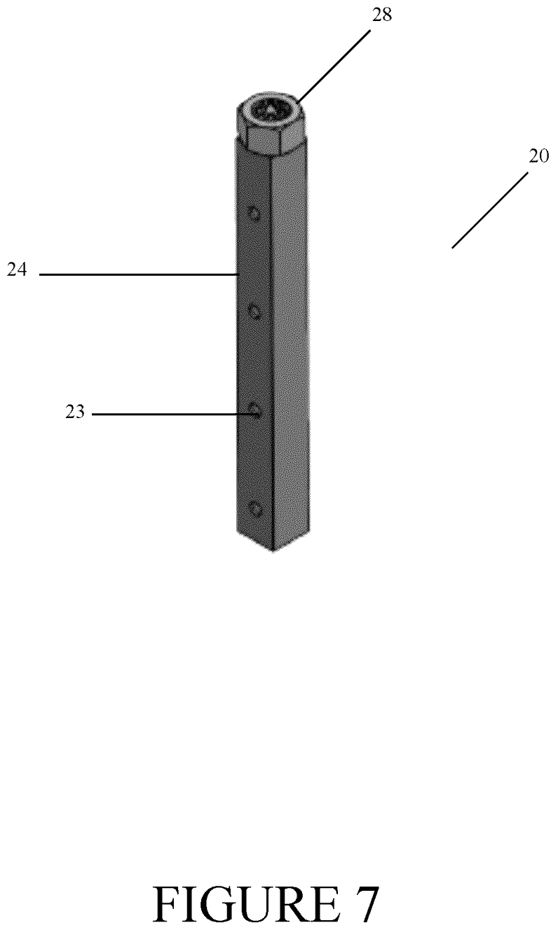

Preferred embodiments of this second sleeve 22 contain an adjustment system that includes one or more holes or apertures 23 traversing the second sleeve 22 from one side to an opposing side. An attachment 20, such as the one shown in FIG. 7, can be inserted into the second sleeve 22. In preferred embodiments, each attachment 20 will include an accessory support column 24 that includes at least one aperture 23 that is complementary in size and shape to the aperture(s) 23 in the second sleeve 22 such that a fastener or locking pin 25 can be inserted through the at last one aperture 23 in the second sleeve 22 and one of a plurality of apertures 23 in the attachment 20 of the support column 24 thereof, thereby holding the attachment 20 in place. The user can then adjust the height of the attachment 20 by removing the locking pin 25, adjusting the position of the attachment 20 with respect to the second sleeve 22 and then reinserting the locking pin 25.

As shown in FIG. 7, preferred embodiments of the jack system 10 include a support column 24 that have an end that features a threaded structure 28 that allows the support column 24 to be attached to another structure. The threads 28 can be male or female and are complementary to threads on the separate structure (not shown). In some embodiments, the threaded structure 28 is a hex nut. The threaded structure 28 allows the user to attach a trailer ball hitch (not shown) of varying sizes depending on the user's needs. This configuration or arrangement is sometimes referred to as the drainage attachment. This attachment is designed to support a device that is rather tall or that needs to be lifted off the ground higher than the average jack will lift. For example, the inventor anticipates this attachment will be useful in supporting marine vessels in a position that allows water to drain out of them. Typical jacks simply are not structured to raise an object high enough to be used for this purpose.

FIG. 1 shows a preferred embodiment of the jack 10 in a fully raised position and FIG. shows an earlier embodiment of the jack 10 in a fully lowered position. As that lever 15 is raised, it pushes the first arm 17 forward. The first arm's 17 forward movement, specifically the movement of the second end (17b) of the first arm (17) causes the second arm 18 to move forward and lower the bracket 19 with the first sleeve 21, the second sleeve 22) and (optionally) the attachment 20. The positioning of the first sleeve 21 allows it to slide along the outer surface of the main support shaft 14. As the user lowers the lever 15, the lever 15 moves the first arm 17 backward until the second end 17b of the first arm 17 is positioned behind the main support shaft 14. More specifically, the first arm 17 extends away from the main support shaft 14 such that the second end 17b extends upward and backward with respect to the main support shaft 14 which is in a direction opposite the side of the system to which the attachment 20 is attached. As discussed above, the positioning of the first arm 17 behind (on the opposite side of) the main support shaft 14 directs or transfers the weight of the bracket 19 (and anything attached thereto) along the longitudinal length (longitudinal axis) of the main support shaft 14. Aa a result, a downward force on the attachment 20 will not produce the lifting force on the lever 15 necessary to cause the first and second arms 17, 18 to swing forward allowing the jack system to fail to support its load. For the load on the attachment to fall, the fasteners that attach the first arm 17 and/or the second arm 18 will have to break. This arrangement transmits the weight of the object being lifted from the second sleeve (18) and/or attachment 20 to the main support shaft 14.

In use, the user attaches the attachment 20 to the rest of the jack system 10 and raises the lever 15 to lower the attachment 20. The jack 10 and attachment 20 system are then moved into position such that the attachment 20 is under a portion of the load to be lifted, in this case, for example, a trailer hitch ball (not shown) is positioned underneath a trailer coupler (not shown). When the lever 15 is lowered, the second arm 18 of the locking mechanism raises the bracket 19 that supports the attachment 20 causing the attachment 20 and the load to which it is attached to raise.

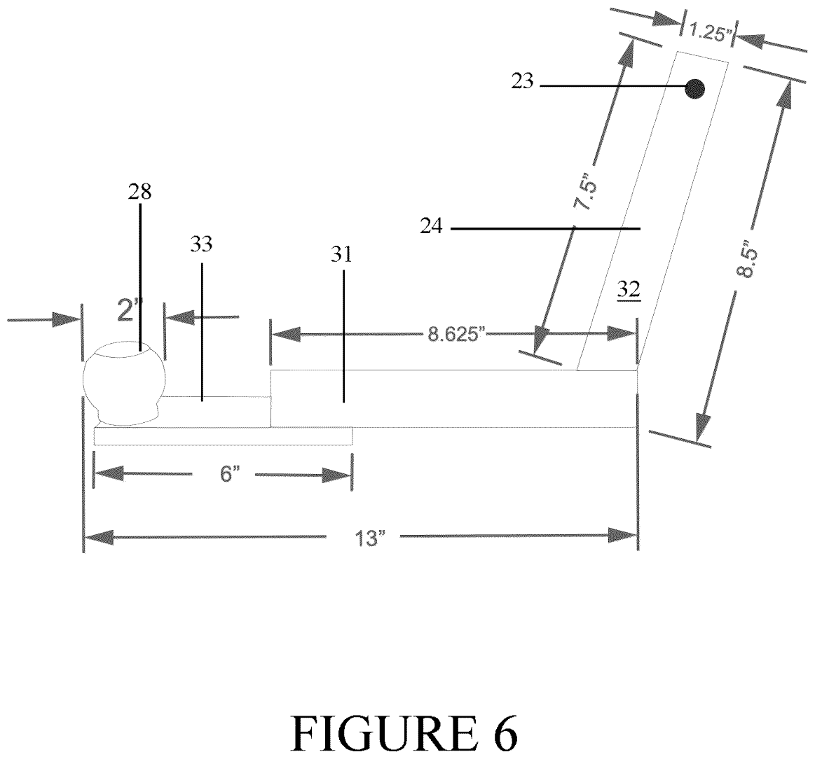

FIG. 6 shows an attachment for the jack system 10 that is sometimes referred to as the drainage attachment. This attachment 20 is designed to support a device that is rather tall or that needs to be lifted off the ground higher than the average jack will lift. For example, the inventor anticipates this attachment will be useful in supporting marine vessels in a position that allows water to drain out of them. Typical jacks simply are not structured to raise an object high enough to be used for this purpose.

FIG. 7 shows a preferred embodiment and the inventor's anticipated best mode of the attachment. This attachment consists of an accessory or attachment support column 24 (attachment support column 24) that includes apertures, holes or bores 23 that completely traverse the attachment support column 24. These holes, as discussed above, are complementary in size and shape to other holes or bores 23 featured by the second sleeve 22 attached to the bracket 19. These structures make up a height adjustment system that allows the user to adjust the height of the accessory that is attached to the attachment support column 24 to suit the user's preferences and needs. This embodiment includes a threaded structure to which a user can attach an additional, separate threaded structure such as a trailer ball hitch (not shown). In use, the user attaches the attachment 20 to the rest of the jack system 10 and raises the lever 15 to lower the attachment 20. The jack system attachment 20 is then moved into position such that the attachment 20 is under a portion of the load to be lifted, in this case, the trailer hitch ball 28 is positioned underneath a trailer coupler (not shown). When the lever 15 is lowered, the second arm 18 of the locking mechanism raises the bracket 19 that supports the attachment 20 causing the attachment 20 and the load to which it is attached to raise.

FIG. 6 shows an alternate embodiment of the attachment 20. In this case, the attachment is designed to allow the jack system 10 to lift or pick up a load that is positioned very close to the ground. Traditional jacks do not have a structure that is designed to extend downward away from the jack to allow the jack system to lift something that is on the ground or very close to it. Current jack systems require a certain amount of space between the ground and the load to be lifted; otherwise, the jack system cannot be positioned effectively. In this variation, the attachment support column 24 extends downward, forward and away from the second sleeve 22 (and bracket 19) allowing the user to place the attachment 20 low to the ground. The attachment support column 24 includes at least one aperture, hole or bore 23 complementary in size and shape to the at least one aperture 23 featured by the bracket 19 or a second sleeve 22 directly attached to the bracket 19. This attachment support column 24 extends downward, and preferably forward, away from the main support shaft 14 and terminates in a third arm 31 that includes a trailer hitch ball 28. Alternately, the attachment support column 24 can feature an angled portion 32. Still other variations will include a third arm 31 that has a flattened portion 33 to which the trailer hitch ball is attached thereby allowing the user to lift an object that is no more than a couple of inches off the ground, such as a fallen trailer.

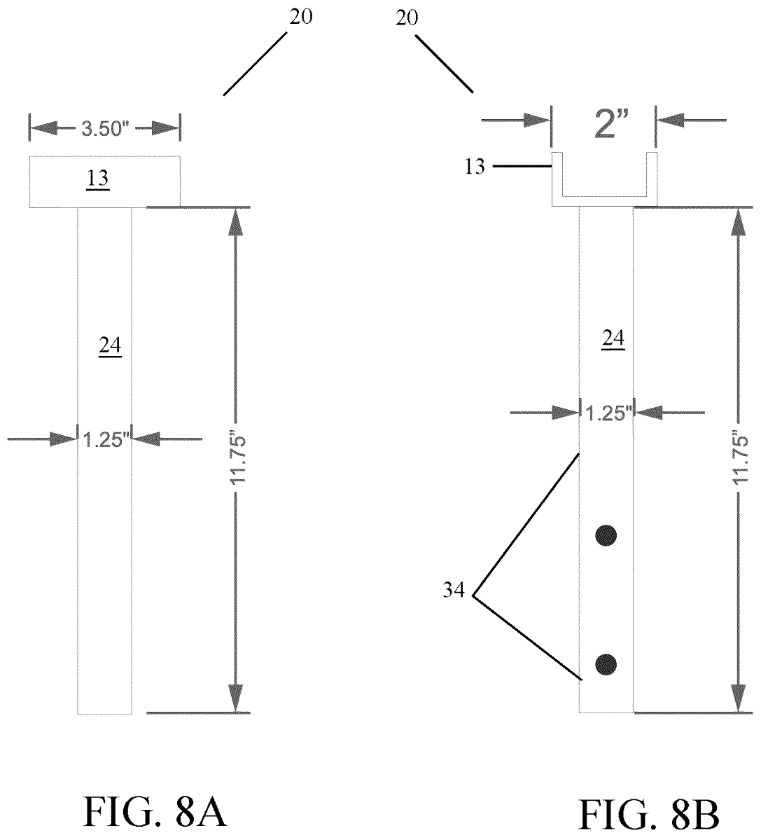

FIGS. 8A and 8B show another embodiment of the jack system with an attachment 20 that uses a U-shaped structure 29. The U-shaped structure or bracket 29 is designed to support a horizontal structure that is not configured to engage with a traditional trailer hitch ball such as the “grab bar” located on the back of a typical all-terrain vehicles. This attachment 20 also includes the same attachment support column 24 with the same height adjustment system 34 that is included in the embodiment shown in FIG. 6.

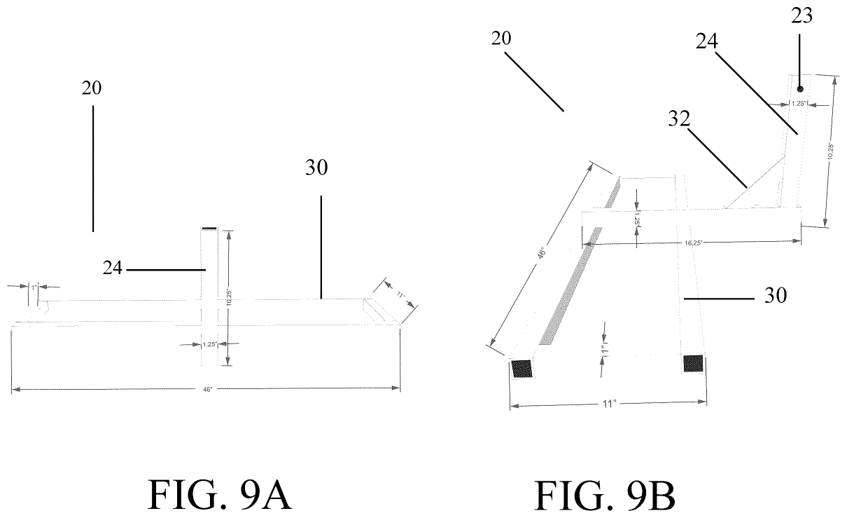

Similarly, FIGS. 9A and 9B show another embodiment of the jack system that uses a cradle attachment 20. This attachment features an attachment support column 24 that is very similar to that used with the embodiment shown in FIG. 6. In this case, the attachment support column 24 features a height adjustment system that includes the same complementary bores, holes or apertures 23 in the attachment support column 24 that are complementary to the same bores, holes or apertures 23 included in the second sleeve 22 through which a fastener (not shown) can be inserted. In this embodiment, the attachment 20 includes a frame 30. Optionally, the attachment support column 24 includes an angled portion 32. The attachment support column 24 extends downward and forward away from the main support shaft 14 and connects to a frame 30. This frame, in its most basic form includes four horizontal supports attached end to end to form a rectangular frame 30. When the attachment 20 is in a lowered position, the frame/cradle is close to or seated on the ground so that a vehicle can be driven onto the frame 30. This embodiment is meant to be used to lift the front end of a vehicle or other piece of equipment such as a lawn mower.

The advantages of the disclosed jack system include, without limitation, the ability to use a single jack with multiple attachments allowing for more versatile uses of the system. In addition, as discussed above, the system is constructed to transmit force along the longitudinal axis of the vertically oriented main support column, where the system in is strongest. The system reduces the risk of the jack system failing as there is no ratchet and pawl system to fail. The system allows the user to lift different structures that would be difficult to lift with a traditional jack system including marine vessels and trailers.

In broad embodiment, the present invention is a novel jack system with a variety of attachments that can increase the utility of the system to perform tasks prior art jack systems cannot. The device is more stable, capable of raising an object or load higher off the ground than standard jacks. In addition, the system includes attachments that allow the user to pick up and support an object that is lower t-o the ground than standard hack systems can accommodate. The jack system is structured so that it is less likely to mechanically fail or to fall. The attachments can be used to raise, among other things, ATVs, marine vessels and fallen trailers.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above-described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A jack that transfers the weight of an object being lifted to a vertically oriented support column comprising:
a base attached to a first end of the vertically oriented support column; wherein the vertically oriented support column extends upward and away from said base;
a first arm with a first end and a second end; wherein the first end of the first arm is pivotably attached to a second end of the vertically oriented support column and the second end of the first arm is pivotably attached to a first end of a second arm;
a second end of the second arm attached to a bracket;
a first sleeve at a first end of the bracket;
a second sleeve located at an opposing second end of the bracket;
a lever attached to the first arm;
wherein raising the lever moves the first arm, the second arm and the bracket from a raised position to a lowered position in which the second end of the first arm is positioned to be in front of the main support column and lowering the lever moves the first arm, the second arm and the bracket from a lowered position to a raised position in which the second end of the first arm is positioned to be behind the main support column.

2. The jack of claim 1 further comprising an accessory support column with at least one aperture that is complementary in size and shape to an aperture passing through the second sleeve; wherein said accessory support column is inserted into the second sleeve.

3. The jack of claim 2 further comprising a threaded structure attached to or integrated into an end of the support column.

4. The jack of claim 2 wherein the attachment support column extends downward and forward form the main support shaft and terminates in a third arm that includes a trailer ball hitch.

5. The jack of claim 4 wherein the third arm includes a flattened portion to which the trailer ball hitch is attached.

6. The jack of claim 3 further comprising a U-shaped bracket attached to the threaded structure.

7. The jack of claim 2 wherein the attachment support column extends downward and forward form the main support shaft and terminates in a third arm that terminates in a frame.
